(19) United States
(12) Patent Application Publication
(10) Pub. No.: US 2019/0029468 A1
(43) Pub. Date: Jan. 31, 2019

(54) METHOD AND APPARATUS FOR OUTDOOR FRYING LARGE FOOD ITEMS SUCH AS A TURKEY

(71) Applicant: Nicholas Bourgeois, Jefferson, LA (US)

(72) Inventor: Nicholas Bourgeois, Jefferson, LA (US)

(21) Appl. No.: 16/046,866

(22) Filed: Jul. 26, 2018

Related U.S. Application Data
(60) Provisional application No. 62/537,583, filed on Jul. 27, 2017.

(51) Int. Cl. A47J 37/12; A23L 5/10; A23L 13/50

(52) U.S. Cl. CPC A47J 37/1219; A47J 37/128; A47J 37/1295; A23V 2002/00; A23L 5/11; A23L 13/50; A47J 37/1242

(57) ABSTRACT

Disclosed is a method and apparatus regarding gaseous fueled fired outdoor cooking or frying devices such as deep fat fryers. More particularly, various embodiments relate to an improved method and apparatus that relates to an outdoor cooking or frying apparatus having a pivoting basket and lit configuration allowing the discharge of large food items such as a full sized turkey onto the lid for preparation immediately before serving the large food item. The lid has cooking, receiving and preparation configurations. The basket has cooking, draining and discharging configurations.

### CROSS-REFERENCE TO RELATED APPLICATIONS

This is a non-provisional of U.S. Provisional Patent Application Ser. No. 62/537,583 filed Jul. 27, 2017, where such application is incorporated herein by reference, and priority to/of such application is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND

Various embodiments relate to a method and apparatus regarding gaseous fueled fired outdoor cooking or frying devices such as deep fat fryers. More particularly, various embodiments relate to an improved method and apparatus that relates to an outdoor cooking or frying apparatus having a pivoting basket and lit configuration allowing the discharge of large food items such as a full sized turkey onto the lid for draining and/or preparation immediately before serving the large food item. The lid has cooking, receiving and preparation configurations. The basket has cooking, draining and discharging configurations.

### BRIEF SUMMARY

Various embodiments relate to a method and apparatus regarding gaseous fueled fired outdoor cooking or frying devices such as deep fat fryers.

In various embodiments the apparatus can include a frame supporting one or more burner elements, the burner element(s) being positioned below a pot that is also supported by the frame.

In various embodiments the pot can be supported by the base. In various embodiments the pot can have a plurality of generally planer side walls, a bottom, and an open top.

In various embodiments a basket can be provided which is sized and shaped to conform to the shape of the pot and occupy the pot interior. In various embodiments the basket can be of a different shape and/or size than the pot interior.

In various embodiments the basket can be pivotally connected to the pot. In various embodiments the pivotal connection can be a hinged connection and include a hinge. In various embodiments the pivotal connection can be a detachable pivotal connection.

In various embodiments a lid can be provided which is sized and shaped to cover the open top of the pot. In various embodiments the lid can be pivotally connected to the pot. In various embodiments the pivotal connection can be a hinged connection and include a hinge. In various embodiments the pivotal connection can be a detachable pivotal connection.

In various embodiments the pivotal connection between the basket and the pot and lid and the pot can share a single axis of rotation. In various embodiments the lid can be both pivotally connected to the basket and pivotally connected to the pot. In various embodiments the pivotal connection can be a hinged connection and include a hinge. In various embodiments the pivotal connection can be a detachable pivotal connection.

In various embodiments the cooker can comprise a base, a pot supported by the base, the pot having a bottom, side walls, an open top, a basket that is sized and shaped to occupy the pot interior, the basket being pivotally connected to the pot at a hinge, a pot lid that removably fits and covers the open top.

Preferably, the basket pivotally connects to the pot with a pinned hinged connection that is removable so that the basket can be separated from the pot by removing the pinned hinged connections.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in any way from the spirit of the present invention. No feature of the invention is critical or essential unless it is expressly stated as being “critical” or “essential.”

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an exploded sided view of one embodiment of an outdoor frying cooker showing the base, pot, basket, and lid.

FIG. 2 is a side view of the outdoor frying cooker of FIG. 1, where the components have been assembled, and where the lid is in an open state.

FIG. 3 is a front view of the outdoor frying cooker of FIG. 2, where the basket is partially raised out of the pot.

FIG. 4 is a top view of the outdoor frying cooker of FIG. 2, where the lid is in an open state.

FIG. 5 is a side view of the outdoor frying cooker of FIG. 2, where the lid has been placed in a closed state.

FIG. 6 is a side view of the outdoor frying cooker of FIG. 2, where the lid has been placed in an open state, a turkey has been placed in the basket at a time when the basket is at least partially raised out of the cooking fluid, and the basket supporting the turkey is being lowered into the cooking fluid for cooking.

FIG. 7 is a side view of the outdoor frying cooker of FIG. 6, where the lid remains in an open state, and the basket supporting the turkey has been completely lowered into the cooking fluid, and the turkey being submerged in the cooking fluid, and the turkey being cooked in the cooking fluid.

FIG. 8 is a side view of the outdoor frying cooker of FIG. 7, where the lid remains in an open state, and where after the turkey has been completely cooked in the cooking fluid, the basket supporting the turkey has been raised to a drainage state, where the turkey is positioned above the top level of the cooking fluid and allowed to drain fluids back into the cooking fluid.

FIG. 9 is a side view of the outdoor frying cooker of FIG. 8.

FIG. 10 is a side view of the outdoor frying cooker of FIG. 8, where the lid remains in an open state, and the basket with cooked turkey has been additionally rotated upwardly compared to FIG. 8 such that the turkey is discharged into the receiving portion of the open lid, and a second stage of fluid drainage from the cooked turkey begins so that any remaining cooking fluid and/or fluids from the cooked turkey drain into the catch on the lid.

FIG. 11 is a side perspective view of the outdoor frying cooker of FIG. 10.

FIG. 12 is an enlarged view of the catch connected to the lid.

FIG. 13 is a side view of the outdoor frying cooker of FIG. 8, where a cook is further processing the cooked turkey on the lid, and remaining cooking fluid and/or fluids from the cooked turkey continue to drain into the catch on the lid.

FIG. 14 is a perspective view of the cook, having detached the pot and basket from the base, is now draining the cooking fluid into a storage container.

FIG. 15 is a side view of an alternative embodiments which can include a steaming plate attachment to the basket.

FIG. 16 is a side view of the basket with steaming plate attached of FIG. 15.

FIG. 17 is an enlarged view of a threaded fastener system which can be used to attach the steaming plate of FIG. 15.

FIG. 18 is a top perspective view of the steaming plate attachment connected to the basket.

FIG. 19 is a perspective view of the steaming plate attachment.

FIG. 20 is a side view of an alternative outdoor frying cooker having a generally flat lid, where the lid is shown in an open state supported by an alternative lid support, and including an alternative catching cup.

FIG. 21 is a perspective view of the alternative catching cup of FIG. 20.

FIG. 22 is a side view of the alternative catching cup of FIG. 20.

FIG. 23 is a side view of the alternative outdoor frying cooker of FIG. 20 where broken lines have been used to show the internal basket and arrows schematically indicate the movement of cooking fluid and/or fluids from the cooked turkey traveling on open lid and draining into alternative catching cup.

### DETAILED DESCRIPTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

General Components of Frame 100, Pot 300, Basket 500, and Lid 800

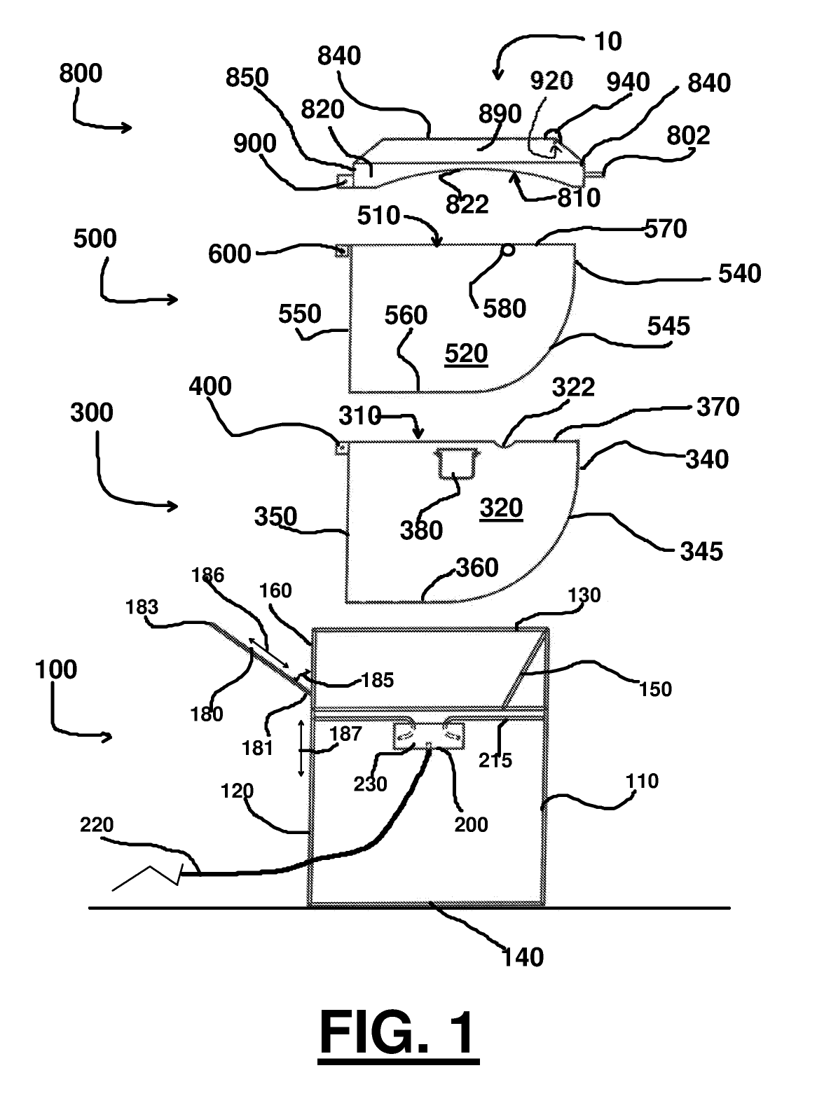

FIG. 1 is an exploded sided view of one embodiment of an outdoor frying cooker showing the base, pot, basket, and lid. Generally, outdoor fryer 10 can comprise base 100, pot 300, basket 500, and lid 800.

The frame or base 100 can have a front 110, rear 120, top 130, and bottom 140. Frame or base 100 can also include a cradling portion 160.

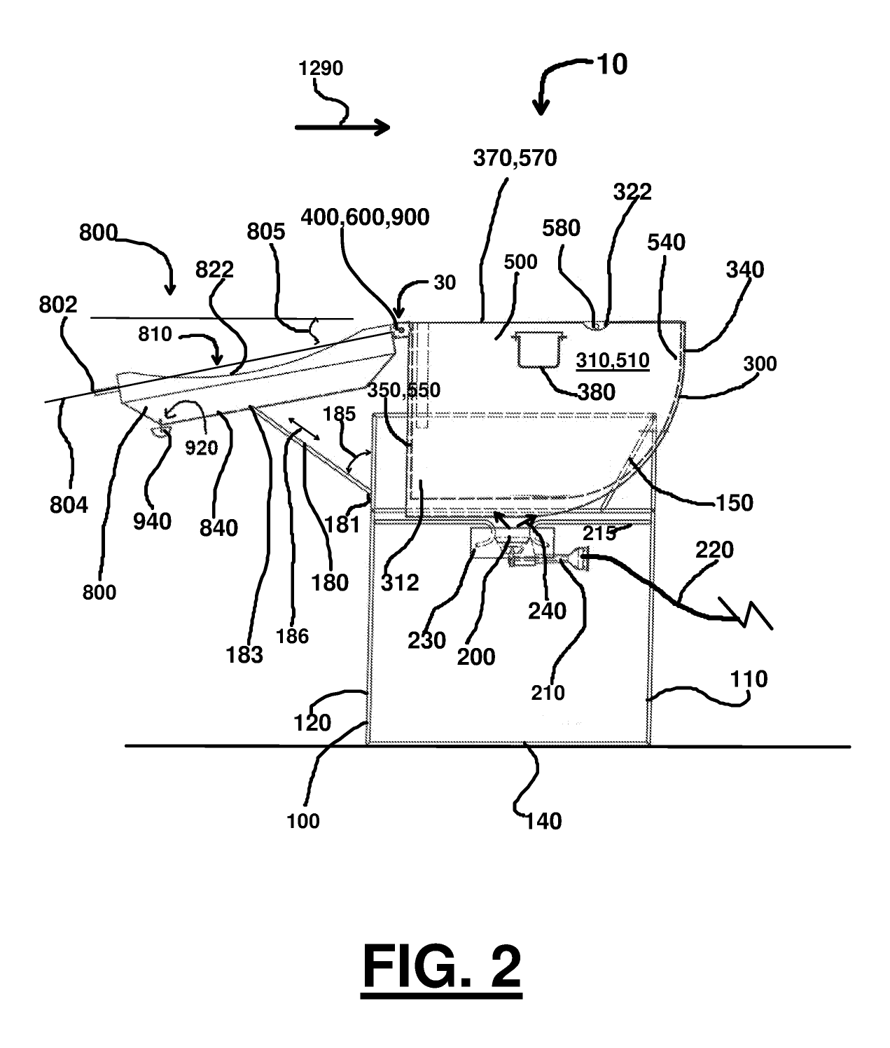

A cradling area 160 can be provided between top 130, beams or struts 215, and optionally heat shield 150. Pot 300 can partially nest in cradling area 160 as schematically shown in FIGS. 2 and 5-8.

Burner element or elements 200 are supported on frame or base 100 via beams or struts 215 for generating a flame or flames for transferring heat to a cooking vessel or pot 300. A heat shield 150 can be provided closer to front 110 of frame or base 100.

Each burner element can include an open ended pipe or tube 210. The burner element(s) 200 are conventional are commercially available. A fuel supply line 220, detachably connectable to pipe or tube 210, can be in the form of a hose or pipe that supplies fuel to each burner element 200. Fuel supply line 220 is provided with an influent fitting for enabling a connection to be made to a fuel supply hose that is connected to a source of fuel such as a pressurized canister of propane or butane or a source of natural gas.

Pot 300 can include a pot interior 310 that is receptive of basket 500. Pot 300 can include a pair of opposed end walls 320, 330, a front section 340, a rear wall 350, and a bottom section 360. Pot 300 can include open top 370 which is substantially planer. Pot 300 can be provided with a pair of handles 380, 382 for enabling one or more users 20 to lift the pot 300 from base 100 for purposes of cleaning and/or disassembly. Pot 300 can include a hinge connection 400 for rotationally connecting to basket 500, along with rotationally connecting to lid 800. Each of the rotational connections between pot 300, basket 500, and/or lid 800 can be detachable.

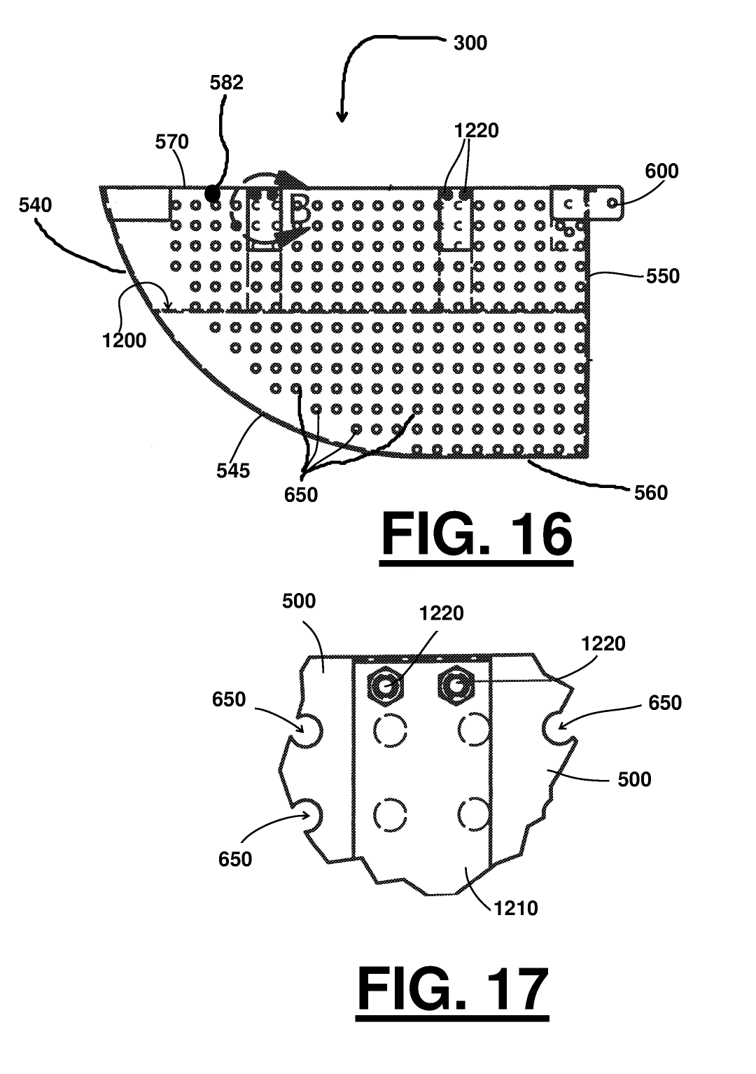

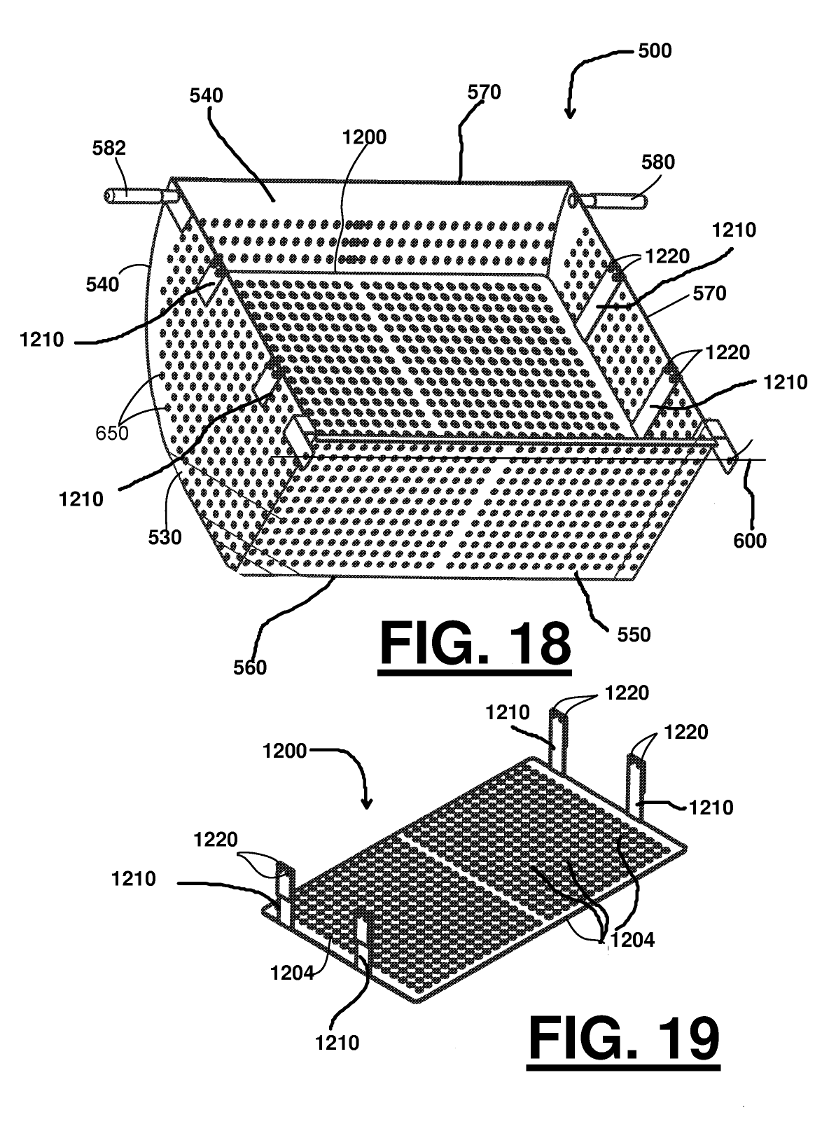

FIGS. 16 and 18 provide views of certain embodiments of basket 500. Basket 500 can be perforated with perforations or openings 650. Basket 500 can have a size and shape that corresponds to pot 300, and include open top 570. Basket 500 can pivotally attach to pot 300 at one or more hinges or pivotal connections 400,600. Basket 500 has end walls 520,530, rear wall 550 and bottom wall 45. In this fashion, basket 500 fits into pot interior 310 during cooking.

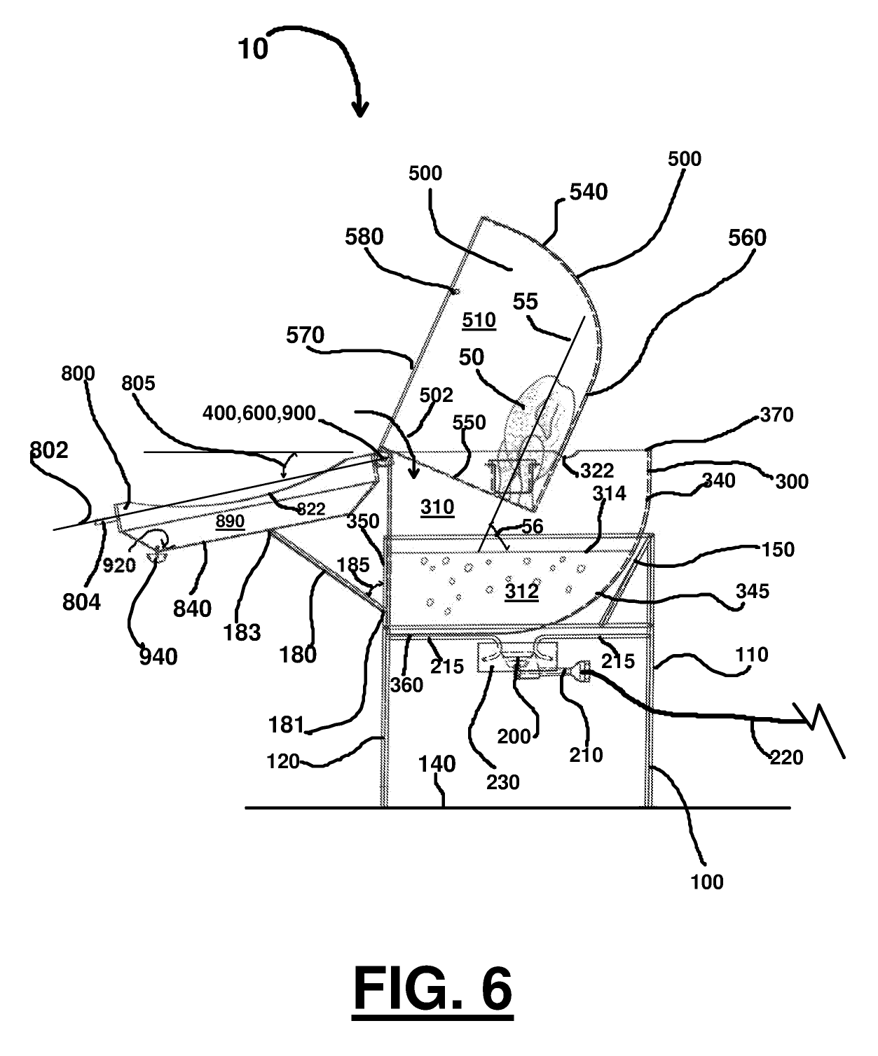

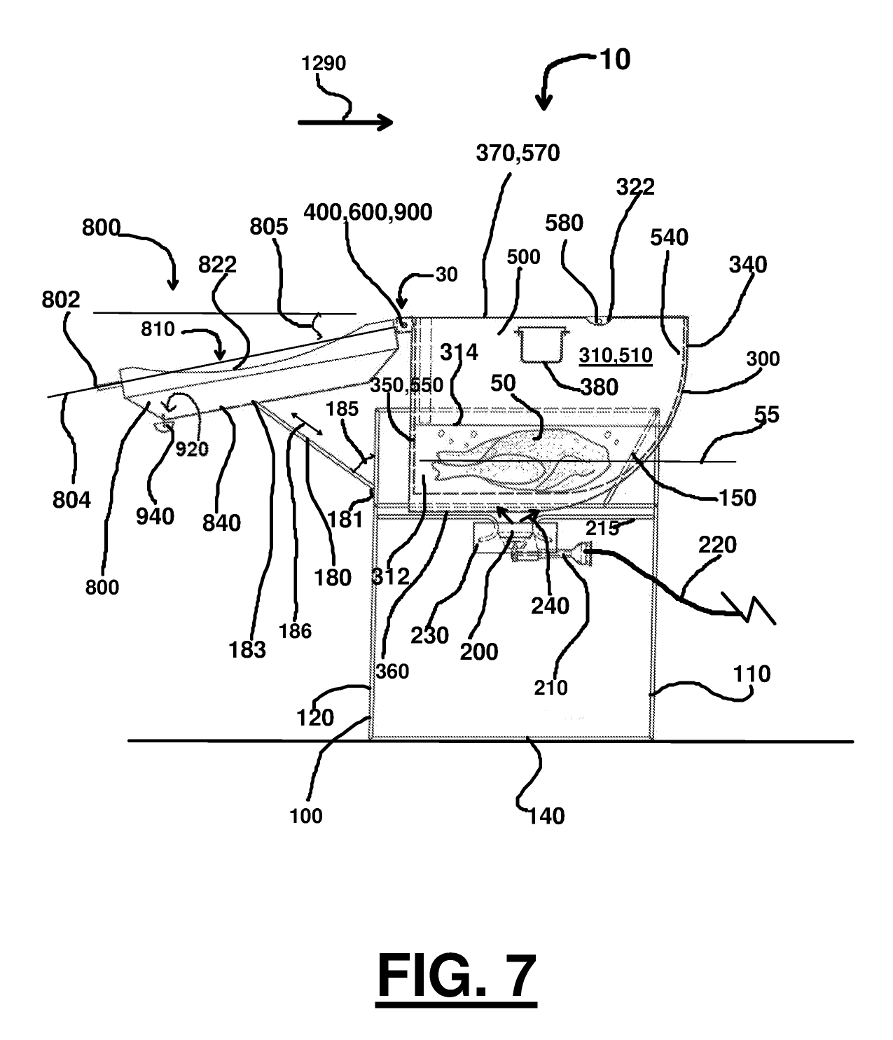

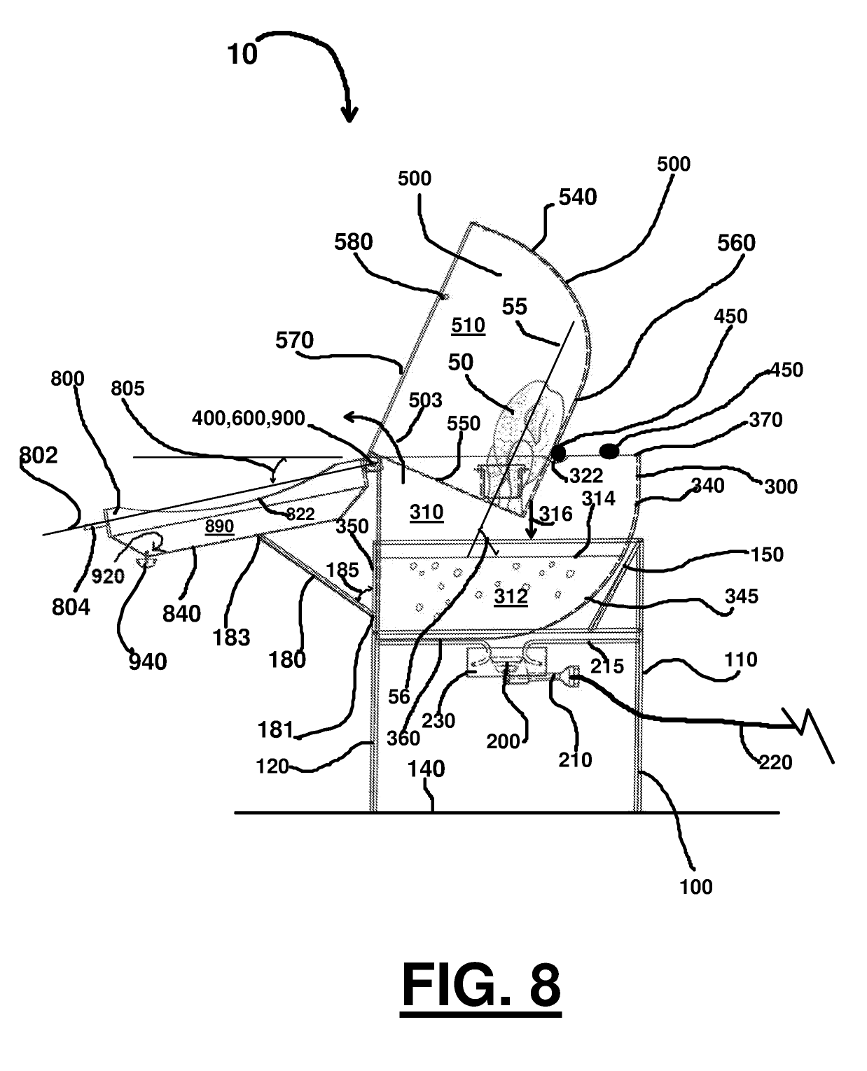

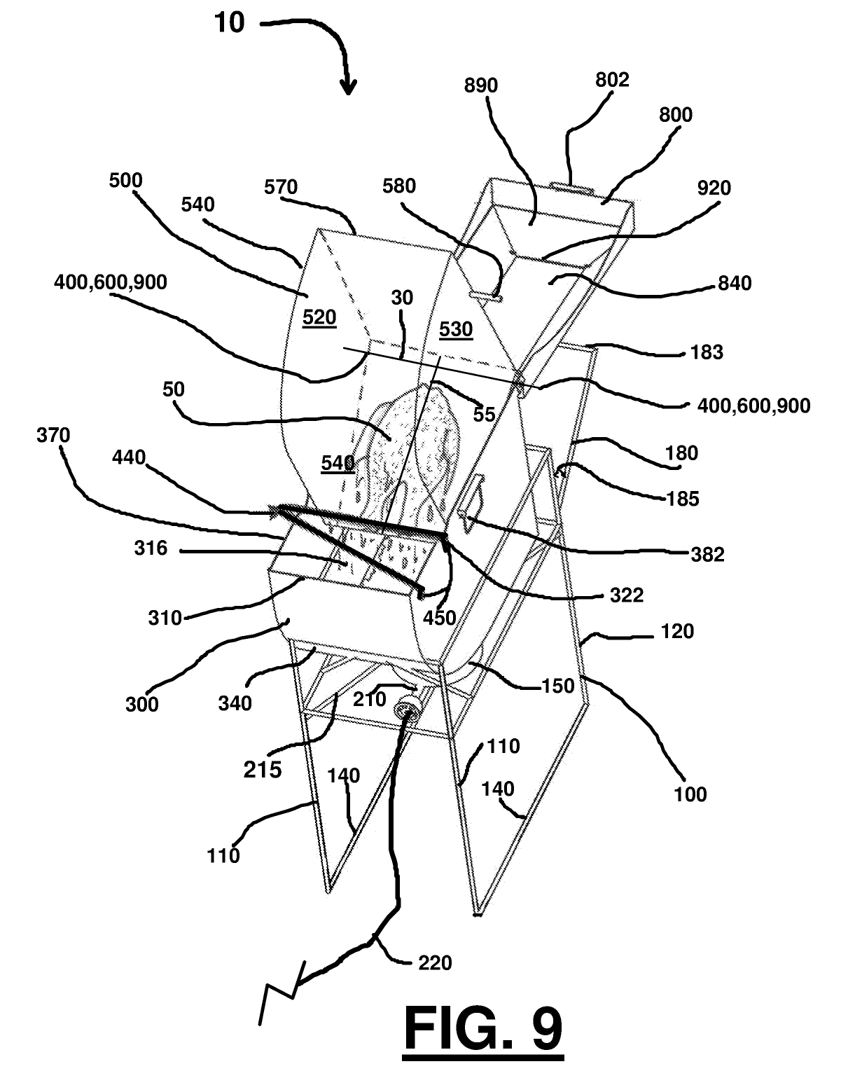

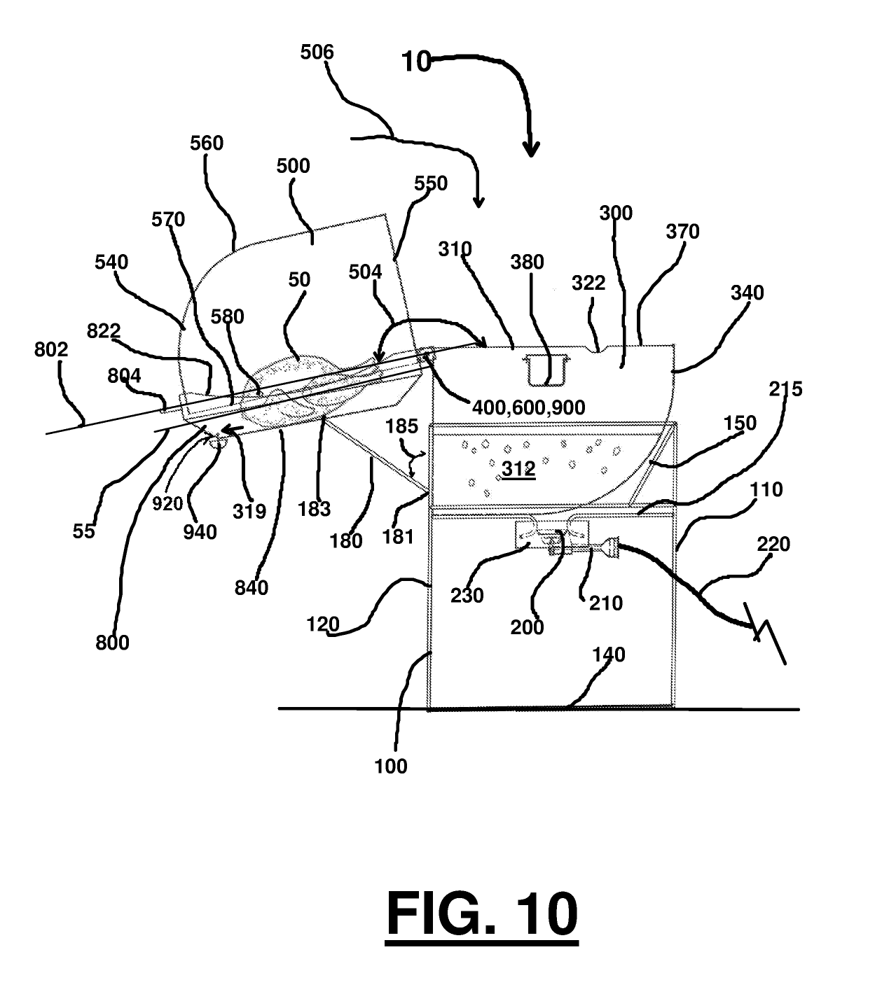

A pair of handles 580, 582 can be provided for lifting basket 500 when emptying its contents. When the handles 580, 582 are lifted upwardly, basket 500 rotates upon its hinges or pivotal connections 400,600 with pot 300. Recesses at 322 can be provided on pot 300 for receiving handles 580,582. When the handles 580,582 are lifted upwardly, basket 500 rotates relative to pot 300 (rotation is schematically indicated by arrow 502 in FIG. 6) from a cooking position (FIG. 7), to an intermediate draining position (FIGS. 8-9), to a discharge position (FIG. 10).

Lid 800 can be provided with end walls 820, 830, front 850 and rear 860 walls, along with a tapered area 890 for containing cooked food item 50 for further preparation.

Closer to second end 840 of lid 800 can be a drainage opening 920 (or plurality of drainage openings). Fluidly connected to drainage openings can be drainage cup 940. In various embodiments drainage cup 940 can be detachably connected to lid 800 via a plurality of connectors 950 (see e.g., FIG. 12).

FIGS. 1-2 show an arrangement for supporting lid 800 in different angularly oriented open positions for receiving food items are to be discharged from basket 500 after cooking in pot 300 is complete. In this arrangement lid 800 can be selectively placed in different angular orientations relative to a horizontal plane.

Frame 100 can include a positionable support 180 which holds lid 800 in a selected position below a horizontal plane (schematically indicated by angle 805). When lid 800 is opened, top 840 of lid 800 can rest upon horizontal section 183. Positionable support 180 can be selectively positionable relative to frame 100 (schematically indicated by angle 185 and/or arrows 186). For example, the vertical height of support beam 183 can be varied by varying the angle 185 of support 180 relative to frame 100. Varying the vertical height of support beam 183 will also vary the angle 805 of top 800 when supported by support beam 183. In an alternative embodiment the distance of support beam in the direction of arrows 186 can be selectively varied (e.g., forming positionable support with telescoping sections) which also will vary the vertical height of support beam 183, and also vary the angle 185 of support 180 relative to frame 100. In another alternative embodiment the vertical height of attachment of support 180 relative to base 100 can also be varied in the direction of arrows 187, which variance will have similar impact on varying the angle 185 of support 180 relative to frame 100.

In various embodiments lid 800 can attach rotationally to pot 300 at hinges 400,900. In various embodiments lid 800 can attach pivotally to basket 500 at hinges 500,900. Lid 800 can provide a handle 804 for lifting lid 800 from a position wherein it covers the open top 370 of pot 300 (and open top 570 of basket 500) to a discharge position (FIG. 7) wherein the lid 800 rotates to a lower sloped position as schematically indicated by angle 805 in FIG. 2. This lower sloped position is preferably between 5 and 25 degrees below a horizontal plane, more preferably between 5 and 20 degrees, more preferably between 5 and 15 degrees, and more preferably between 10 and 15 degrees.

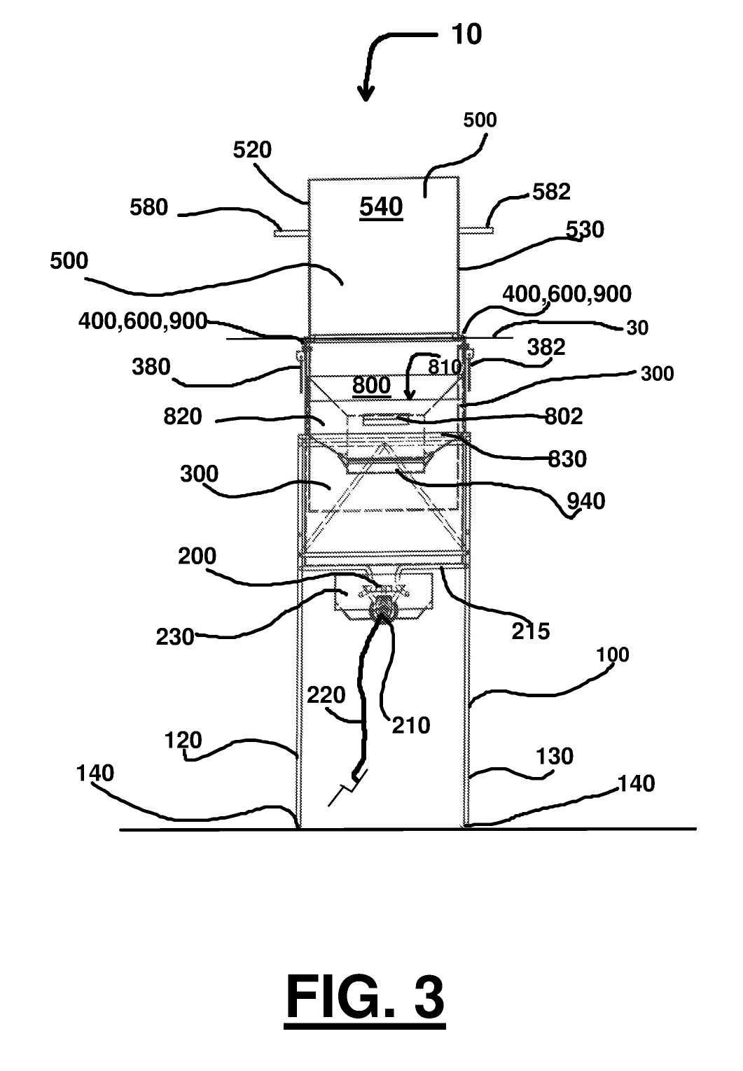

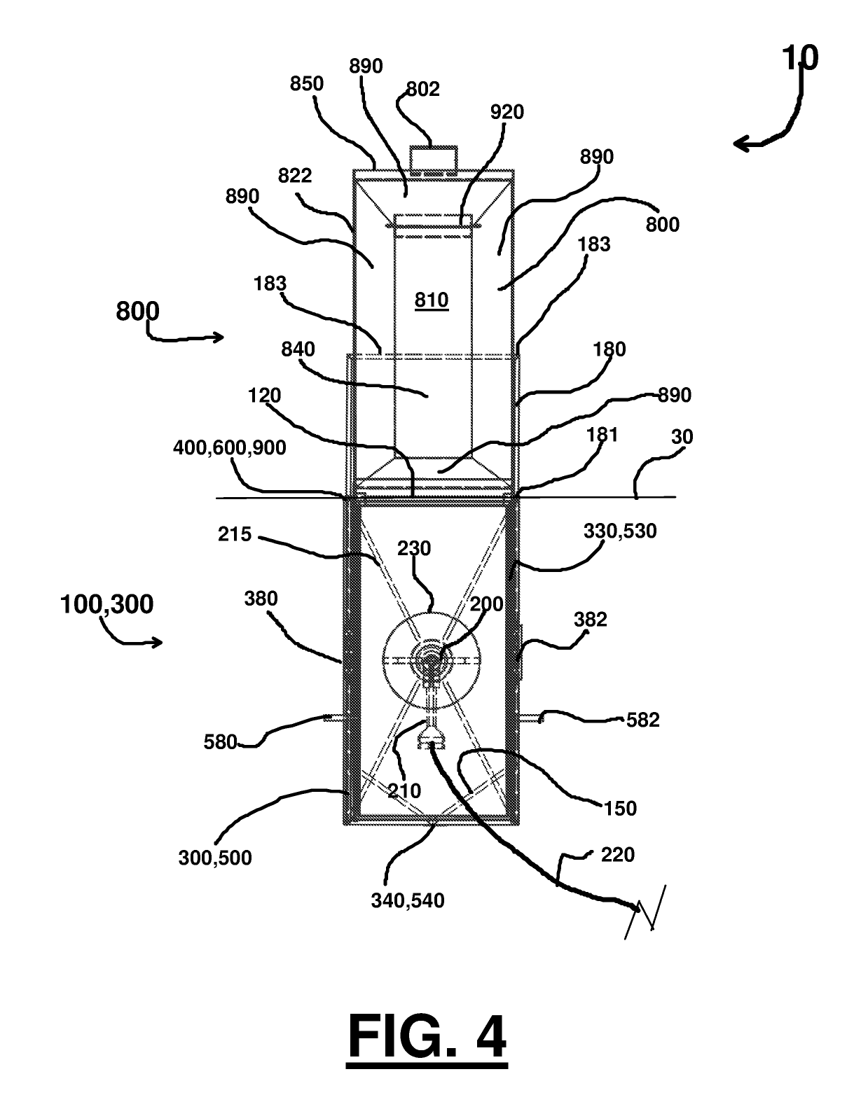

FIG. 2 is a side view of the outdoor frying cooker 10, where the components (pot 300, basket 500, and lid 800) have been assembled, and where the lid 800 is in an open state. FIG. 3 is a front view of the outdoor frying cooker 10, where the basket 500 is partially raised out of the pot 300. FIG. 4 is a top view of the outdoor frying cooker 10, where the lid 800 is in an open state and the basket 500 is located in the interior 310 of pot 300.

Rotational Movement Among Pot 300, Basket 500, and Lid 800.

In various embodiments, base 100 can support pot 300, and pot 300 can be detachably supported by base 100.

In various embodiments basket 500 can be rotationally connected to pot 300 at hinges 400 and 600.

In various embodiments lid 800 can be rotationally connected to pot 300 at hinges 400 and 900.

In various embodiments lid 800 can be rotationally connected to basket 500 at hinges 500 and 900.

In various embodiments the rotational connection between basket 500 and pot 300 and between lid 800 and pot 300 can share a single axis of rotation 30.

In various embodiments the rotational connection between basket 500 and pot 300 and between lid 800 and pot 300 are on spaced apart axes of rotation, but where the spaced apart axes of rotation are substantially parallel to each other.

Method of Cooking and Preparation of Large Food Item 50

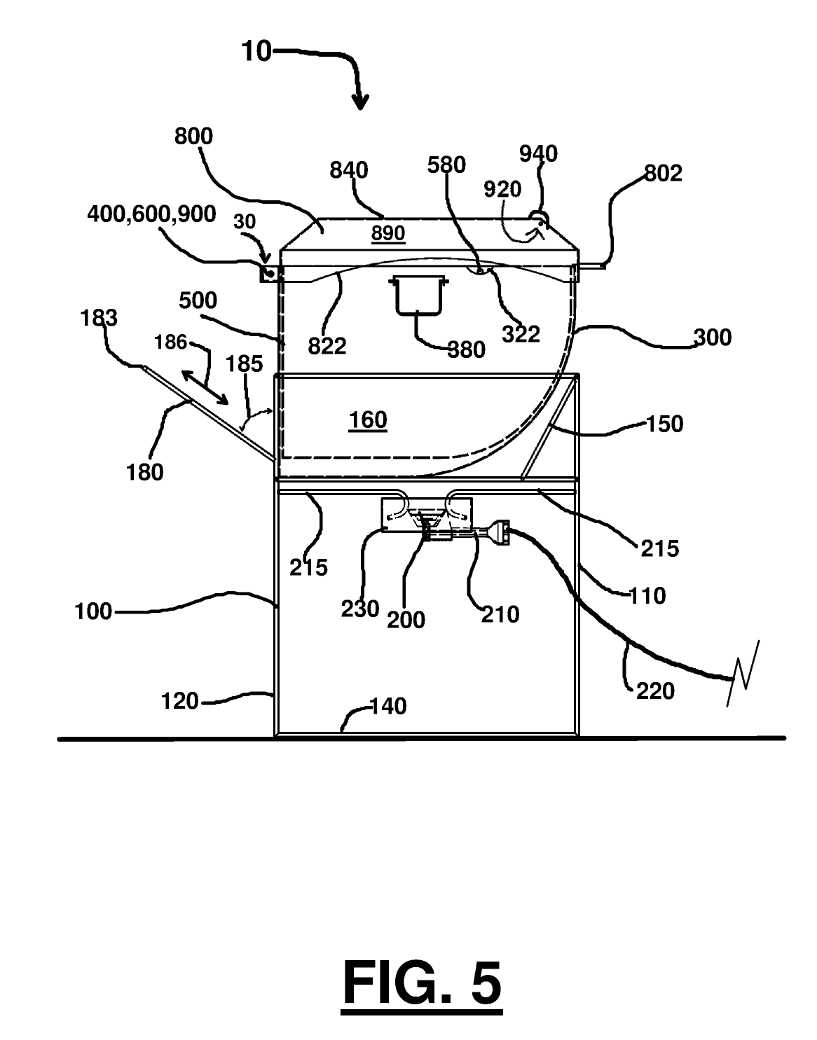

FIGS. 5 through 13 schematically illustrate one embodiment of the method of cooking a large food item 50 using the outdoor frying cooker 10.

FIG. 5 is a side view of the outdoor frying cooker 10, where the components (frame 100, pot 300, basket 500, and lid 800) have been assembled, and where the lid 800 has been placed in a closed state. This can be for example during storage of the cooker 10 while not in use.

A first step would user 20 placing the lid 800 in an open state.

User 20 also places cooking fluid 312 into pot 300 to provide an acceptable top level 314 of cooking fluid 312.

User 20 operates burner 200 to heat cooking fluid 312 contained in pot 300 to an acceptable starting temperature.

User 20 inserts into pot 300 the large food item 50 to be cooked. FIG. 6 is a side view of the outdoor frying cooker 10, where the lid 800 has been placed in an open state, a large food item 50 (e.g., turkey) has been placed in the basket 500 at a time when the basket 500 is at least partially raised out of the cooking fluid 312, and the basket 500 supporting the turkey 50 is being lowered into the cooking fluid 312 for cooking. Preferably, the cooking fluid 312 has been heated to a predesignated temperature before inserting large food item 50 into cooking fluid 312.

To prevent undesirable splashing and/or splattering of heated cooking fluid 312 from pot 300 which can cause injury and/or damage, basket 500 can be used to both support and controllably lower (using relative rotation of basket 500 and pot 300) large food item 50 into interior 370 of pot 300 and into cooking fluid 312. In FIG. 6 a turkey 50 has been placed in the basket 500 at a time when the basket 500 is at least partially raised out of the cooking fluid 312 and the basket 500 while supporting the turkey 50 can be lowered into cooking fluid 312 via rotation of basket 500 relative to pot 300. Arrow 502 in FIG. 6 schematically indicates that the basket 500 supporting the turkey 50 is being carefully lowered into the cooking fluid 312 for cooking (e.g., arrow 502 schematically indicates clockwise rotation of basket 500/turkey 50 relative to pot 300 in a controlled manner so that hot cooking fluid 312 does not splash and/or splatter outside of pot 300 when turkey 50 enters the cooking fluid 312.) During insertion of turkey 50 into interior 570 of basket 500, a user 20 can hold steady the position of basket 500 using one of the handles 580,582, and continue to use the same handle controlling handle to carefully lower the basket 500 and supported large food item (which supports the turkey 50) into the hot cooking fluid 312. The rotational connection 400 between basket 500 and pot 300 takes most of the load of the large food item 50 so that a user 20 can easily lower the basket 500/large food item 50 regardless of the weight of the large food item 50 up to the weights specified in this application. After insertion of the large food item 50 (e.g., turkey) into the interior 510 of the basket 500, the basket 500 supporting the large food item 50 can be rotated at least 25 degrees about the axis of rotation 400 between the basket 500 and pot 300 to submerge the large food item 50 into the cooking fluid 312. In various embodiments the amount of rotation about the axis of rotation 400 can be at least 25, 30, 35, 40, 45, 50, 55, 60, 65, 70, 75, 80, 85, 90, 95, 100, 135, or 180 degrees. In various embodiments the amount or rotation between basket 500 supporting large food item 50 and pot 300 about axis of rotation 400 can fall within a range of between any two of the above specified angular amounts of rotation from the point of insertion of large food item 50 into basket 500 for support to the point of submersion of large food item 50 into cooking fluid 312. In various embodiments the point of submersion can be considered the point at which basket 500 nests within pot 300 to that open top 570 of basket is substantially at the same level as open top 370 of pot (or when rear wall 550 of basket 500 is at its closest point to rear wall 350 of pot 300 such as shown in FIG. 7).

FIG. 7 is a side view of the outdoor frying cooker 10, where a large food item 50 (e.g., turkey 50) is being cooked in a cooking fluid 312. One or more burner elements 200 can provide flames (schematically indicated by arrows 240) to heat cooking fluid 312 and a large food item 50 such as a whole turkey. Preferably, lid 800 remains open during cooking. Also preferably, during the cooking process the central longitudinal axis 55 of food item 50 remains substantially horizontal.

In various embodiments the weight of a large food item 50 which is a single animal carcass is at least 5 pounds. In various embodiment the weight of a large food item 50 is at least 5, 6, 7, 8, 9, 10, 11, 12, 13, 14, 15, 16, 17, 18, 19, 20, 22, 24, 25, 26, 28, 29, 30, 32, 34, 36, 38, 40, 42, 44, 46, 48, 50, 55, 60, 65, 70, and 75 pounds. In various embodiments the weight of the single carcass large food item 50 can fall within a range of between any two of the above referenced minimum weights for the food item 50.

After the large food item 50 has been cooked in cooking fluid 312, basket 500 can be used to lift large food item 50 to an intermediate draining position where large food item is spaced above the top 314 of hot cooking fluid 312. FIG. 8 is a side view of the outdoor frying cooker 10, where the lid 800 is open, the basket 500 is partially raised, and cooking fluid from a cooked turkey 50 is being drained into the cooking fluid 312 (drainage being schematically indicated by arrow 319). FIG. 9 is a front perspective view of the outdoor frying cooker 10, where the lid 800 is open, the basket 500 is partially raised, and cooking fluid 316 from a cooked turkey 50 is being drained into the original cooking fluid 312. Stop 440 can hold basket 500 in the intermediate drainage position.

Lifting the basket 500 with a food item 50 located in the basket 500 using relative rotation between basket 500 and pot 300 causes the food item 50 to be lifted out of the cooking fluid 300 to an intermediate draining position (FIGS. 8-9), and ultimately to a discharge position (FIG. 10) onto the lid 800 for further preparation by a user 20. Arrow 504 schematically indicates the raising of basket 500 about its axis of rotation 600. After food item 50 is fully cooked, it can be raised to an intermediate position where cooking fluid and other fluids are allowed to drain in the cooking fluid 312. Arrow 316 schematically indicates that fluids are draining from food item 50.

Stop 440 can be a support beam of various construction such as the “V” shape shown in FIG. 9 and include a plurality of prongs 450 for connection to outdoor fryer 10 (FIG. 9 schematically shows the connection with pot 300 and supporting basket 500 (via recess 322 in pot 300). In one embodiment, one of the prongs 450 of stop 440 can be located in a recess 322 of pot 300, and the length of stop 440 is such that it spans both sides of pot 300 (FIG. 9), with the interaction between prong 450 and recess 322 keeping stop 440 from sliding relative to pot 300. In another embodiment, to temporarily support basket 500 in a selected intermediate draining position, one of the prongs 450 of stop 440 can be inserted into one of the plurality of opening 650 of basket 500, and basket 500 lowered towards pot 300; wherein stop 440 sticking out of the hole in which stop 440 was inserted will act as a support when stop 440 comes into contact with pot 300 holding basket in the selected intermediate draining position.

When raising to the intermediate draining position, the central longitudinal axis 55 of food item 50 can be raised from a generally horizontal position to an angle 56. This raised angular position 56 is large enough to move food item above the top 314 level of cooking fluid 312 for drainage, and is preferably between 15 and 60 degrees above a horizontal plane, more preferably between 20 and 50 degrees, more preferably between 25 and 45 degrees, and more preferably between 30 and 45 degrees.

When rasing to the intermediate draining position, the food item can change from not being supported by rear 550 to becoming at least partially supported by rear 550 of basket 500. In various embodiments food item 50 first comes into contact with rear 550 of basket during the movement from cooking position to intermediate draining position. In various embodiments the fraction of partial support provided by rear 550 of basket 500 is about equal to the sin(angle 56) where the remainder of the support for food item 50 is provided by bottom 560 of basket 500. This fraction is calculated using static force analysis in relation to the weight of food item 50 and the two items providing support during drainage (i.e., rear 550 and bottom 560 of basket 500).

While in the intermediate draining position, food item 50 located above cooking fluid 312 can remain in the basket 500 for a first draining and/or cooling period during which time period drainage of cooking fluid (schematically indicated by arrow 316 in FIG. 8) occurs and/or food item 50 can cool from its temperature during cooking. In various embodiments first drainage period is at least half a minute. In various embodiments the first drainage period is as least 1, 2, 3, 4, 5, 6, 7, 8, 9, 10, 11, 12, 13, 14, 15, 16, 17, 18, 19, 20, 25, and/or 30 minutes. In various embodiments the first drainage period can fall within a range of between any two of the above referenced drainage periods.

After the step of intermediate draining is completed, the food item 50 can be discharged from basket 500 into the receiving portion of lid 800. Discharge can be accomplished by using one or both of the handles 580,582 to rotate further (schematically indicated by arrow 503) basket 500 about its rotational axis with respect to pot 300. During this further rotation the angle 56 of the central longitudinal axis 55 of food item 50 increases to at least greater than 90 degrees, and preferably at least greater than 100, 110, 120, 130, 135, 140, 150, 160, 170, 180, or 225 degrees. In various embodiments the angle 56 increases to an angle falling within a range of between any two of the above referenced degree amounts. In various embodiments, before complete discharge of food item 50 from the interior 570 of basket 500, the fraction of partial support provided by rear 550 of basket 500 increases to 1 so that the bottom 560 of basket 500 provides no support to food item and the rear 550 provides one hundred percent of support to food item 50.

At some point during discharge of food item 50, food item 50 will move from interior 570 of basket 500 to receiving portion of lid 800. FIG. 10 is a side view of the outdoor frying cooker 10, where the lid 800 is open, the basket 500 with cooked turkey 50 has been rotated into the open lid 800 (schematically indicated by arrows 504). The receiving portion of lid 800 can be interior 810, which is preferably constructed to prevent food item 50 from sliding out of interior 810 notwithstanding the downward sloping configuration of lid 800 (schematically indicated by angle 805 in FIG. 8). In the embodiment shown in the figures prevention of sliding out is accomplished by front wall 850 and side walls 820,830.

After discharge the angle 56 of the central longitudinal axis 55 of food item 50 has at least increased to greater than 180 degrees. In various embodiments the angle of increase is about equal to 180 degrees plus angle 805 of lid 800.

While located in interior of lid 800, food item 50 can enter a separate stage of drainage along with being prepared/processed for serving and/or eating. FIG. 10 is a side view of the outdoor frying cooker 10, where the lid 800 is open, the basket 500 with cooked turkey 50 has been rotated into the open lid 800 (schematically indicated by arrows 504), and any remaining cooking fluid and/or fluids from the cooked turkey 50 continue to drain into the catch 940 on the lid 800 (schematically indicated by arrow 318).

While located in the interior of lid 800, food item 50 can remain in the interior of lid 800 for a second time period. In various embodiments the second time period is at least half a minute. In various embodiment the second time period is as least 1, 2, 3, 4, 5, 6, 7, 8, 9, 10, 11, 12, 13, 14, 15, 16, 17, 18, 19, 20 minutes. In various embodiments the second period can fall within a range of between any two of the above referenced second time periods

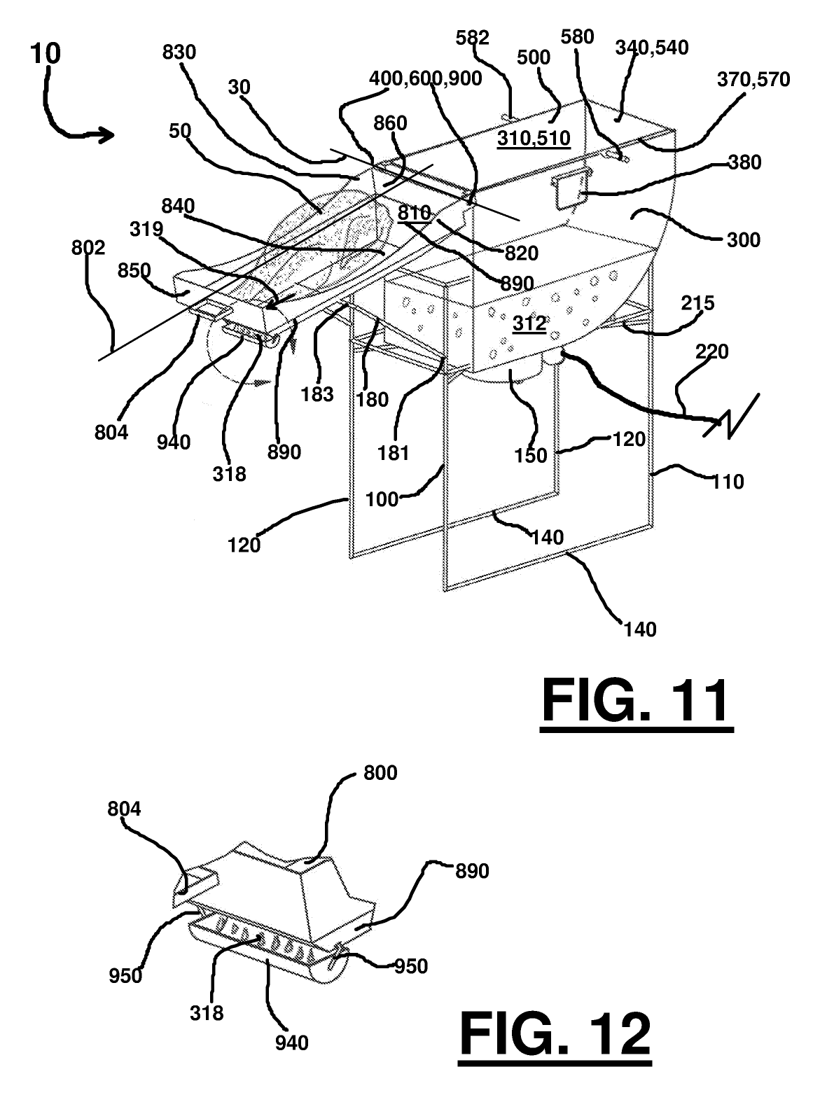

FIG. 11 is a side perspective view of the outdoor frying cooker 10, where the lid 800 is open and the basket 500 has been rotated back into the pot 300, leaving the cooked turkey 50 one the lid 800 for further preparation, and any remaining cooking fluid and/or fluids from the cooked turkey 50 continue to drain into the catch 940 on the lid 800 (schematically indicated by arrow 318). FIG. 12 is an enlarged view of the catch 940 connected to the lid 800. The connection can be made by a plurality of supports 950. Any fluids 318 would drain (schematically indicated by arrow 319) along top 800 and towards 940, passing through drainage opening or openings 920 in lid 800 and entering the interior of catch.

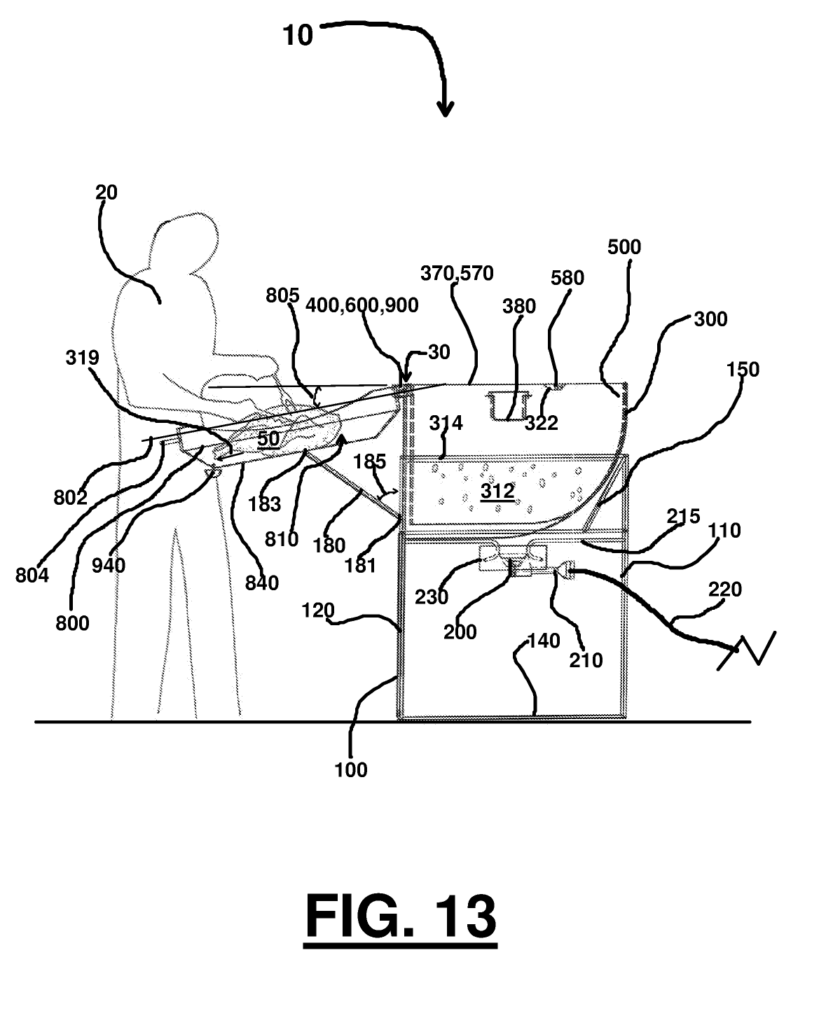

The downwardly sloping nature of lid 800 in its position shown in FIGS. 11 and 13 causes the fluids 318 to move in the direction of arrow 319 through plurality of openings 920 and into catch 940. In various embodiments the downwardly sloping lid 800 when supported by support 180 can form an angle 805 with a horizontal plane which is between any two of the following downwardly sloping angles 1, 2, 3, 4, 5, 6, 7, 8, 9, 10, 11, 12, 13, 14, 15, 16, 17, 18, 19, 20, 25 and 30 degrees.

Although not preferred, in an alternative embodiment lid 800 in its supported position with support 180 can form an upwardly sloping angle with respect to a horizontal plane. In various embodiments the upwardly sloping lid 800 when supported by support 180 can form an upwardly sloping angle with a horizontal plane which is between any two of the following angles 1, 2, 3, 4, 5, 6, 7, 8, 9, 10, 11, 12, 13, 14, 15, 16, 17, 18, 19, 20, 25 and 30 degrees. In these alternative embodiments catch 940 and plurality of openings 920 can be located under rear wall 860 of lid 800. In this instance catch 940 and plurality of drainage openings 920 would be located next to pivot 30.

The embodiment shown in FIG. 12 for catch 940 has the advantage of serving as a pressure relief vent for interior 370 of pot 300 if lid 800 is closed during cooking. In this situation pressure inside of interior 370 of pot 300 will increase and such increased pressure will migrate through drainage opening(s) 920 causing catch 940 to raise and allowing escape of the increased pressure before pressure increases to a dangerous level.

FIG. 13 is a side view of the outdoor frying cooker 10, where a cook 20 is further processing the cooked turkey 50 on the lid 800, and any remaining cooking fluid and/or fluids from the cooked turkey continue to drain into the catch 940 on the lid 800 (schematically indicated by arrow 318).

It is noted that FIGS. 10-13 schematically illustrate a second stage of drainage for large food item 50 (compared to the stage of drainage that occurs in the intermediate drainage position schematically shown in FIGS. 8 and 9) wherein this second stage of drainage has continued drainage of fluid 318 from large food item 50 is in a direction 319 away from large food item 50 and towards catch 940. This second stage of drainage occurs where the central longitudinal axis 55 of large food item is positioned at a different angular orientation relative to the angular orientation of the longitudinal axis 55 in the intermediate drainage position. During the second stage of drainage the fluid drippings 318 are allowed to leave the interior 810 of lid 800 (traveling through drainage 920 and into catch 940) while the large food item is maintained in the receiving portion of lid 800, and not allowed to leave.

Further processing while being located on receiving area of lid 800, can include cutting and/or carving and/or seasoning of large food item 50.

In various embodiments the method can include the additional step of catch 940 collecting a first quantity of secondary drippings 318 from food item 50 while food item is supported by lid 800, and this first quantity of secondary drippings 318 being poured over or mixed with food item 50. In various embodiments the pouring over and/or mixing of secondary drippings 319 with food item 50 can be done during the process of preparing food item 50. In various embodiments the secondary drippings 319 can be poured over or mixed with food item 50 while food item 50 is supported by lid 800. In various embodiments catch 940 holding secondary drippings 319 can be detached from lid 800 and then the catch 50 is used to pour over or mix the secondary drippings 319 with food item 50. In various embodiments the first quantity of secondary drippings 319 collected by catch 940 can be poured over or mixed with food item 50 at a time when food item 50 is not supported by lid 800.

Drainage and Cleaning of Pot, Basket, and Lid

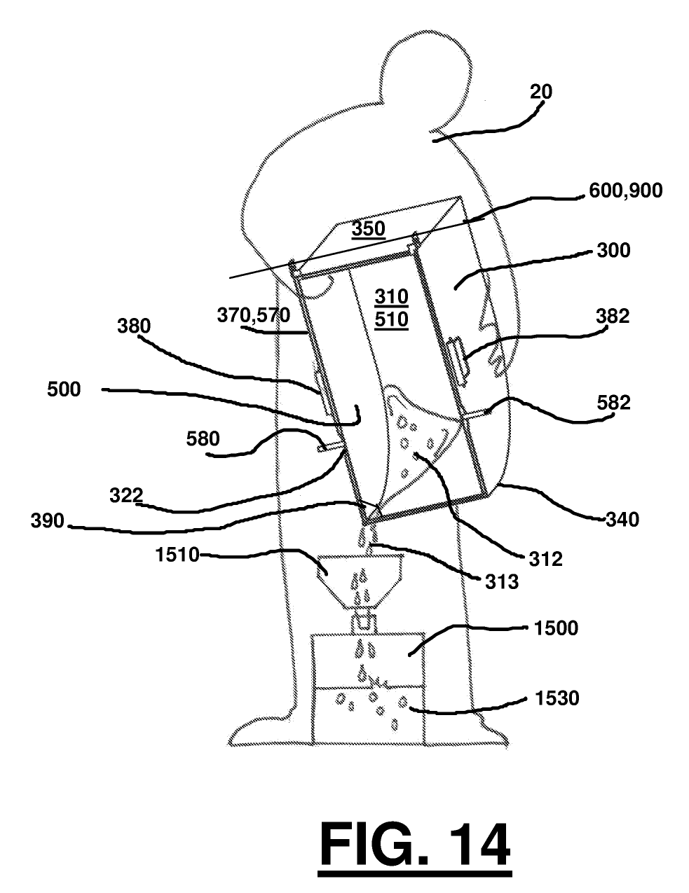

After cooking is complete, fluid 300 contained within pot 300 can be drained by lifting pot 300 out of the cradling portion 160 of frame or base 100 and tipping pot 300 as schematically indicated by FIG. 14. FIG. 14 is a perspective view of the cook 20, having detached the pot 300 and basket 500 from the frame or base 100, is now draining the cooking fluid 312 into a storage container 1500 (schematically indicated by stream 313 of fluid).

During this process, preferably user 20 maintains basket 500 position inside of pot 300. During this draining process, lid 800 can be detached from pot 300 and basket 500.

It is also noted that pot 300 in this embodiment includes a pour spout 390.

Steaming Plate Alternative Embodiment

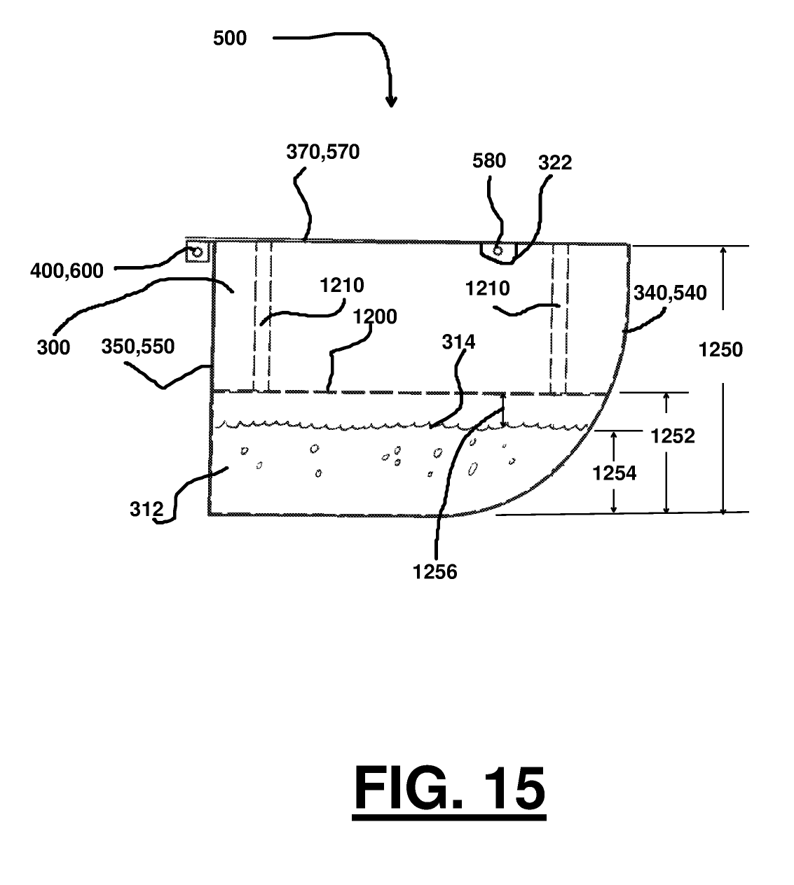

FIG. 15 is a side view of an alternative embodiments which can include a steaming plate 1200 attachment to the basket 500. FIG. 16 is a side view of the basket 500 with steaming plate 1200 attached. FIG. 17 is an enlarged view of a threaded fastener system 1220 which can be used to attach the steaming plate 1200. FIG. 18 is a top perspective view of the steaming plate 1200 attachment connected to the basket 500. FIG. 19 is a perspective view of the steaming plate 1200 attachment.

In FIGS. 15-19, a steamer plate 1200 can be bolted to basket 500 for enabling food items to be steamed. In such a case, water 300 is placed in pot 300 but filled to a level 314 that is below the steamer plate 1200 (providing gap 1256). The steamer plate 1200 can be bolted at 1220 using a plurality of supports 1210 so that it can be removed when not needed. During steaming, the steamer plate 1200 can be generally horizontally supported in basket 500 about one quarter to one half the distance between the top 570 and bottom 560 of basket 500 (see FIGS. 15-16).

Generally Flat Lid and Alternative Catch/Cup

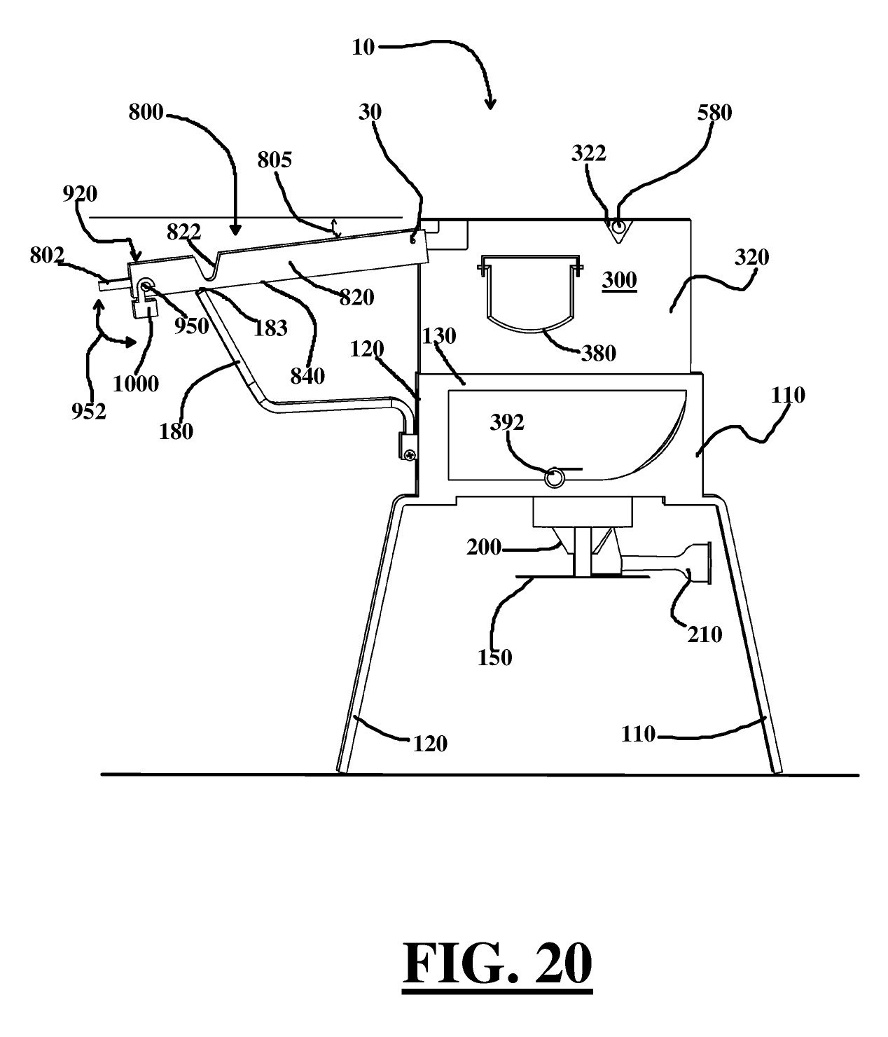

FIG. 20 is a side view of an alternative outdoor frying cooker 10′ having a generally flat lid 800 where lid 800 is rotatively connected to pot 300. In this embodiment pot 300 can include drainage valve 392. Additionally, burner 200 can include heat shield 150 which heat shield can be a generally flat plate, and pot 300 can include a drainage valve 392. In FIG. 12 lid 800 is shown in an open state supported by an alternative lid support 180.

Alternative catch/cup 1000 can be detachably supported by lid 800, and can also be rotatively connected to lid 800. Arrows 952 schematically indicate the ability of alternative catch/cup 1000 to rotate/pivot relative to lid 800.

Generally flat lid 800 can include a generally flat top 840, handle 802, and a plurality of side walls. In two of the sidewalls can be a recess 822 which accommodates handles 580 for basket 500. Generally flat lid can be rotatively/pivotally connected to pot 300 and/or basket 500. In the open position generally flat lid 800 can be supported by lid support 180, and lid support 180 can itself serve as a handle for positioning and/or moving base/frame 100. Generally flat lid 800, when supported by lid support 180, can form a downwardly sloping angle 805 with a horizontal plane which is between any two of the following downwardly sloping angles 1, 2, 3, 4, 5, 6, 7, 8, 9, 10, 11, 12, 13, 14, 15, 16, 17, 18, 19, 20, 25 and 30 degrees.

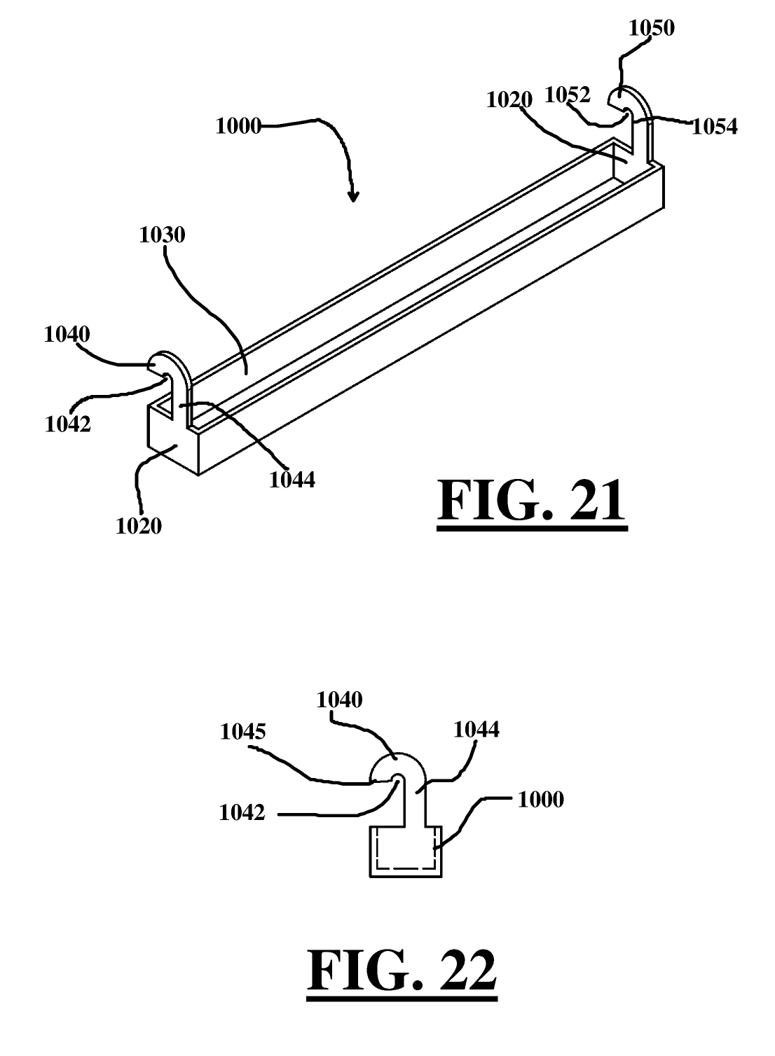

FIG. 21 is a perspective view of the alternative catching cup 1000. FIG. 22 is a side view of the alternative catching cup 1000. Catch container can include first end 1010, second end 1020, and interior 1030. At first end can be first arm 1040, and first arm can include strut 1044 with arcuate head and end 1045 (arcuate head forming an interior 1042). At second end 1020 can be second arm 1050, and first arm can include strut 1054 with arcuate head and end 1055 (arcuate head forming an interior 1052).

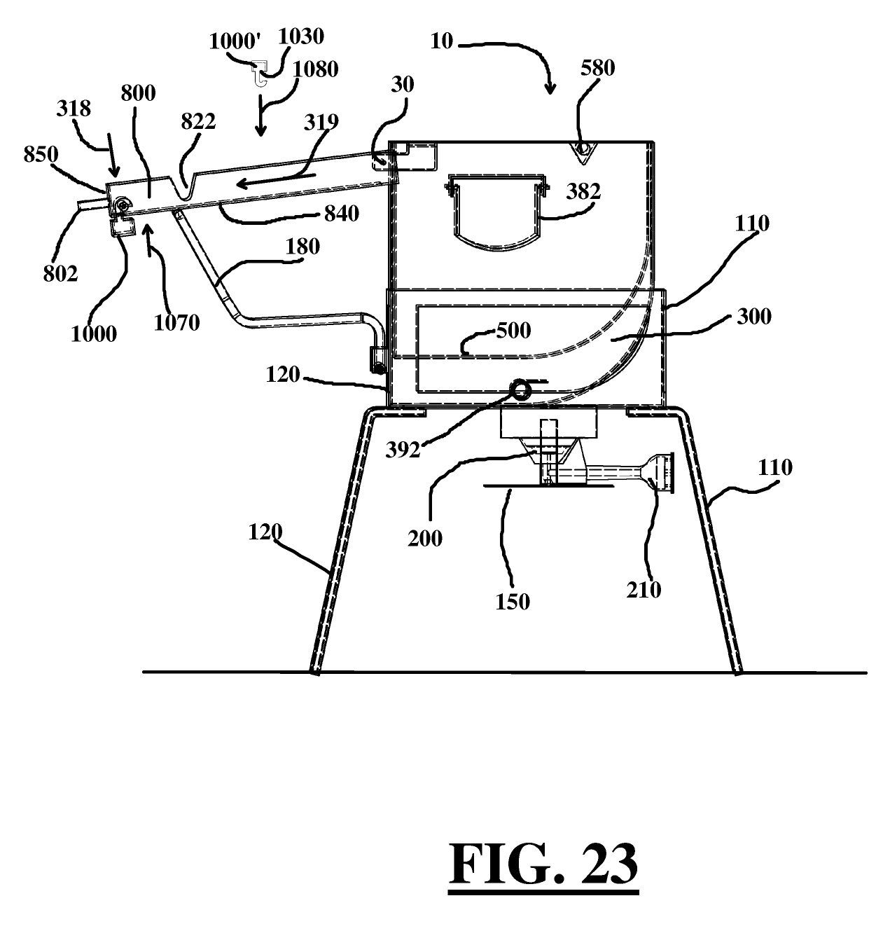

FIG. 23 is a side view of the alternative outdoor frying cooker 10′ where broken lines have been used to show the internal basket 500 and arrows schematically indicate the movement of cooking fluid and/or fluids from a cooked turkey (not shown for clarity) traveling on open lid 800 and draining into alternative catching cup 1000. Further processing while being located on receiving area of lid 800, can include cutting and/or carving and/or seasoning of large food item 50.

In various embodiments the method can include the additional step of alternative catch/cup 1000 collecting a first quantity of secondary drippings 318 from food item 50 while food item 50 is supported by lid 800, and catch/cup 1000 being used to pour and/or mix this captured first quantity of secondary drippings 318 onto/with food item 50. During the food item 50 processing step while food item is supported by lid 800 (schematically shown in FIG. 13), alternative catch/cup 1000 being partially or completely filled with secondary drippings 318 can be detached from lid 800, and then these captured secondary drippings 318 being poured out of catch/cup 1000, and then catch/cup 1000 again attached to lid 800 to further catch additional secondary drippings 318′ from the same food item 50 being processed on lid before catch/cup 1000 was first detached from lid 800 and used to pour secondary drippings onto food item 50.

FIG. 23 schematically shows the process of detaching alternative catch 1000 from lid 800 (schematically indicated by arrow 1070) at a time when alternative catch 1000 contains a first quantity of secondary drippings 318 in its interior 1030, and then pouring this first quantity of secondary drippings 318 over food item 50 (schematically indicated by catch 1000′ and arrow 1050 where food item 50 has been omitted for clarity but would be under arrow 1080 (similar to the location of food item 50 shown in FIG. 13). In various embodiments the pouring over and/or mixing of secondary drippings 319 with food item 50 can be done during the process of preparing food item 50. In various embodiments the secondary drippings 319 can be poured over or mixed with food item 50 while food item 50 is supported by lid 800. In various embodiments catch 1000 holding secondary drippings 319 can be detached from lid 800 and then the catch 1000 is used to pour over or mix the secondary drippings 319 with food item 50. In various embodiments the first quantity of secondary drippings 319 collected by catch 1000 can be poured over or mixed with food item 50 at a time when food item 50 is not supported by lid 800.

In various embodiments is provided the option of cooking with lid 800 being closed and alternative catch/cup 1000 being located above plurality of drainage openings 920, which openings then act as a pressure relief valve, and then when lid 800 is open alternative catch/cup 1000 being used to contain secondary drippings 318.

### TABLE OF REFERENCE NUMERALS

The following is a table of reference numerals used in this application:

| Parts Number | Description |
|---|---|
| 10 | outdoor fryer |
| 20 | operator |
| 30 | axis of rotation |
| 50 | large food item to be cooked |
| 55 | central longitudinal axis |
| 56 | first angle from generally horizontal |
| 100 | base/frame |
| 110 | front |
| 120 | rear |
| 130 | top |
| 140 | bottom |
| 150 | heat shield |
| 160 | cradling portion of base/frame |
| 170 | top |
| 180 | positionable lid support |
| 181 | first end |
| 183 | second end |
| 185 | angle |
| 200 | burner |
| 210 | open ended pipe or tube |
| 215 | support beams |
| 220 | fuel supply hose |
| 230 | wind shield |
| 240 | flame or flames |
| 300 | pot |
| 310 | pot interior |
| 312 | cooking fluid |
| 313 | drained cooking fluid |
| 314 | top level of cooking fluid |
| 316 | drippings |
| 318 | secondary drippings |
| 319 | arrow |
| 320 | end wall |
| 322 | recess |
| 330 | end wall |
| 332 | recess |
| 340 | front wall |
| 345 | curved portion |
| 350 | rear wall |
| 360 | bottom wall |
| 370 | upper edge |
| 380 | handle |
| 382 | handle |
| 390 | pour spout |
| 400 | hinge(s)/pivotal connection(s) |
| 440 | stop |
| 444 | first end |
| 448 | second end |
| 450 | plurality of prongs |
| 500 | basket |
| 502 | arrow |
| 503 | arrow |
| 504 | angle |
| 506 | arrow |
| 510 | basket interior |
| 520 | end wall |
| 530 | end wall |
| 540 | front wall |
| 545 | curved portion |
| 550 | rear wall |
| 560 | bottom wall |
| 570 | upper edge |
| 580 | handle |
| 582 | handle |
| 600 | hinge(s)/pivotal connection(s) |
| 650 | plurality of perforations/openings |
| 800 | lid |
| 801 | angle |
| 802 | handle |
| 804 | central longitudinal axis |
| 806 | angle below generally horizontal plane |
| 810 | lid interior |
| 820 | end wall |
| 822 | recess |
| 830 | end wall |
| 832 | recess |
| 840 | top |
| 850 | front wall |
| 860 | rear wall |
| 870 | upper edge |
| 876 | side wall |
| 890 | tapered perimeter |
| 900 | hinge(s)/pivotal connection(s) |
| 920 | drainage openings |
| 940 | catch cup |
| 941 | first end |
| 942 | interior |
| 944 | second end |
| 950 | connectors |
| 952 | arrows |
| 1000 | catch container |
| 1010 | first end |
| 1020 | second end |
| 1030 | interior |
| 1040 | first arm |
| 1042 | interior |
| 1044 | strut |
| 1045 | end |
| 1050 | second arm |
| 1052 | interior |
| 1054 | strut |
| 1055 | end |
| 1070 | arrow |
| 1080 | drippings |
| 1200 | steamer plate |
| 1204 | plurality of openings/perforations |
| 1210 | plurality of supports |
| 1220 | bolted connection |
| 1250 | dimension |
| 1252 | dimension |
| 1254 | dimension |
| 1256 | dimension |
| 1290 | arrow |
| 1500 | cooking fluid container |
| 1510 | funnel |
| 1530 | used cooking fluid stored |

All measurements disclosed herein are at standard temperature and pressure, at sea level on Earth, unless indicated otherwise. All materials used or intended to be used in a human being are biocompatible, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A method of processing a large food item, comprising the steps of:
a) providing an outdoor cooking unit having
(i) a base;
(ii) a pot that rests upon the base, the pot having a bottom wall, side walls, a pot upper rim, an open top, and a pot interior;
(iii) a basket that is sized and shaped to occupy the pot interior, the basket pivotally connecting to the pot at a hinge, the basket having a bottom panel and multiple side wall panels and multiple basket openings;
(iv) a pot lid having an interior portion forming a receiving portion, the lid having open and closed conditions, wherein the lid removably fits and covers the open top in the closed position and the receiving portion of the lid being exposed in the open position and forming an angle relative to a generally horizontal plane which is at least 5 degrees below the generally horizontal plane;
b) placing the pot lid in an open position, and placing cooking fluid in the pot interior,
c) placing the large food item in the interior of the basket so that the basket supports the large food item, while the large food item is supported by the basket rotating the basket relative to the pot until the large food item is submersed in the cooking fluid;
d) heating the cooking fluid to cook the large food item;
e) after step “d”, rotating the basket and food item to place the food item into an intermediate drainage position and allowing cooking fluids to drain from the food item;
e) after step “e”, additional rotation of the basket causing the food item to be at least 95 percent supported by the rear of the basket during such continued rotation;
f) after step “f”, additional rotation of the basket causing the food item to be discharged from the interior of the basket and onto the receiving portion of the lid;
g) after step “g”, while the food item is on the receiving portion of the lid where a second stage of fluid drainage occurs whereby the fluid drained from the large food item leaves the receiving portion of the lid, the food item is prevented from leaving the receiving portion of the lid.

2. The method of claim 1, wherein the food item of step “b” has a weight that exceeds 20 pounds.

3. The method of claim 1, wherein in step “c” the food item has a central longitudinal axis which is generally horizontal, and during steps “e” and “f” the central horizontal axis of the food item rotates more than 180 degrees.

4. The method of claim 1, wherein in step “a” the lid and basket both are rotatable about a single longitudinal axis relative to the pot.

5. The method of claim 1, wherein in step “a” the lid includes a catch supported by the lid, the catch being fluidly connected to the interior of the lid, and in step “h” fluids drain from the food item into the interior of the lid, through a drainage opening in the lid, and out of the interior of the lid into the catch.

6. The method of claim 1, wherein during step “c” the lid is placed in the closed position and the catch operates as a pressure vent in relation to the interior of the pot.

7. The method of claim 1, wherein the lid includes a block which during step “g” the block preventing the food item from leaving the receiving portion of the lid.

8. The method of claim 1, wherein during step “g” processing of the food item is done by at least by cutting the food item into multiple pieces.

9. The method of claim 1, wherein during the entirety of step “d” the lid is an open condition.

10. The method of claim 1, wherein in step “a” the basket has a planar rear wall that forms a connection with the rotational axis between the basket and the pot.

11. The method of claim 1, wherein in step “a” the lid forms an angle with the generally horizontal plane which falls between 5 and 25 degrees below the generally horizontal plane.

12. A method of processing a large food item, comprising the steps of:
a) providing an outdoor cooking unit having
(i) a supporting base having a burner and a portable source of cooking gas;
(ii) a pot supported by the base, the pot having a bottom wall, side walls, a pot upper rim, an open pot top, and a pot interior;
(iii) a basket that is sized and shaped to occupy the pot interior, the basket pivotally connecting to the pot at a hinge, the basket having a bottom, multiple side wall panels, an open basket top, a basket interior, and a plurality of basket perforations;
(iv) a pot lid having an interior portion forming a receiving area, the lid having open and closed states, wherein the lid removably fits and covers the open pot and basket tops in the closed position and the receiving portion of the lid being exposed in the open position and forming an angle relative to a generally horizontal plane which is at least 5 degrees below the generally horizontal plane;
b) placing cooking fluid in the pot interior;
c) placing the large food item in the interior of the basket so that the basket supports the large food item, and while the large food item is supported by the basket rotating the basket relative to the pot until the large food item is submersed in the cooking fluid;
d) after step “c”, rotating the basket and food item to place the food item into an intermediate drainage position and allowing cooking fluids to drain from the food item;
e) after step “d”, additional rotation of the basket causing the food item to be at least 95 percent supported by the rear of the basket during such continued rotation;
f) after step “e”, additional rotation of the basket causing the food item to be discharged from the basket interior and onto the receiving portion of the lid;
g) after step “f”, while the food item is on the receiving portion of the lid processing of the food item, and a second stage of fluid drainage occurs whereby the fluid drained from the large food item leaves the receiving portion of the lid but the food item remains on the receiving portion of the lid.

13. The method of claim 12, wherein the food item of step “c” has a weight that exceeding 20 pounds.

14. The method of claim 12, wherein in step “c” the food item has a central longitudinal axis which is generally horizontal, and during steps “d” and “e” the central horizontal axis of the food item rotates more than 180 degrees.

15. The method of claim 12, wherein in step “a” the lid and basket both are rotatable about a single longitudinal axis relative to the pot.

16. The method of claim 12, wherein in step “a” the lid includes a catch supported by the lid, the catch being fluidly connected to the interior of the lid, and in step “g” fluids drain from the food item into the interior of the lid, through a drainage opening in the lid, and out of the interior of the lid into the catch.

17. The method of claim 12, wherein during step “c” the lid is placed in the closed position and the catch operates as a pressure vent in relation to the interior of the pot.

18. The method of claim 12, wherein the lid includes a block wherein during step “f” the block prevents the food item from leaving the receiving portion of the lid.

19. The method of claim 18, wherein the block is a wall.

20. The method of claim 12, wherein in step “a” the basket has a planar rear wall that forms a connection with the rotational axis between the basket and the pot.

21. The method of claim 12, wherein in step “a” the lid forms an angle with the generally horizontal plane which falls between 5 and 25 degrees below the generally horizontal plane.

22. The method of claim 12, wherein in step “e” removing the pot and basket from the frame and draining the cooking fluid from the pot interior while maintaining the basket in the pot interior.

23. The method of claim 22, wherein the lid it detached from its connection to the pot before draining the cooking fluid from the pot interior while maintaining the basket in the pot interior is performed.
